(19) United States
(12) Patent Application Publication
(10) Pub. No.: US 2007/0264880 A1
(43) Pub. Date: Nov. 15, 2007

(54) CONNECTOR FOR THE TRANSMISSION OF SIGNALS, IN PARTICULAR FOR THE CONTACTLESS INDUCTIVE TRANSMISSION OF MEASUREMENT SIGNALS

(76) Inventors: Jens Schiffer, Potsdam (DE); Wolfgang Feucht, Berlin (DE)

Correspondence Address: MCGLEW & TUTTLE, PC, P.O. BOX 9227, SCARBOROUGH STATION, SCARBOROUGH, NY, 10510-9227, US

(21) Appl. No.: 11/747,370

(22) Filed: May 11, 2007

(30) Foreign Application Priority Data
May 12, 2006 (DE) 10 2006 022 713.1

(51) Int. Cl. H01R 13/514

(52) U.S. Cl. 439/752

(57) ABSTRACT

A connector for the transmission of signals has
a socket part (6)
a plug part (5), which engages with it,
an annular locking element (7) between the socket and plug parts (5, 6) to fix the insertion position of the plug part (5) inside the socket part (6) and
a respective seal (28, 32) in the region of the front ends (29, 30) of the annular locking element (7) to seal the engagement zone between plug and socket parts (5, 6) against the penetration of substances from outside.

### BACKGROUND OF THE INVENTION

1. Field of the Invention

The invention relates to a connector for the transmission of signals, in particular for the contactless inductive transmission of measurement signals.

2. Background Art

Connectors of this type have a socket part, a plug part, which engages with it, and an annular locking element between the socket and plug parts, which fixes the insertion position of the two connector elements.

A similar connector coupling described in this way is known from DE 103 52 159 A1, in which two coupling members are fixable to each other with a bayonet lock, which locks them together. This connector coupling serves for the contactless inductive transmission of measurement signals, for which purpose inductive interfaces are arranged in each coupling member. Although the two coupling members do each have a hermetically sealed housing, this publication does not disclose the extent to which the engagement zone of the two coupling members is sealed from the exterior as a result. The coupling members consist of a plug-type coupling member and a socket-type coupling member, which is pushed over the plug coupling member with part of the bayonet lock in the manner of a clamping nut and rotated.

The known connector couplings have the problem that substances can penetrate the non-sealed engagement zone between the two coupling members. Although this is not detrimental to inductive, non-contact signal transmission, connector couplings of this type are often used for the signal connection between measurement sensors and what are known as field devices in production plant in the food, pharmaceutical, biotechnological and other chemical industries, where strict demands are made on hygiene and cleanability of the equipment used. In this respect, the known connectors are problematic, since substances can penetrate between the connector parts. This is particularly problematic in the field of the present connector, because deep, very narrow annular gaps are involved on account of the plug and socket parts used.

### SUMMARY OF THE INVENTION

Starting from the described problem, the object of the invention is to design a connector of the generic type so that it can be cleaned better and without any problems as regards hygiene.

The object is achieved by the invention, according to which the connector is provided with respective seals in the region of the front ends of an annular locking element, which provide for complete sealing of the engagement zone between plug and socket parts against the penetration of substances from outside. Thus the gap zones between plug and socket parts, which are problematic in terms of hygiene, are hermetically sealed, and the whole connector has the effect of being an integral whole owing to the sealing of the region of the locking element. Thus it can also be cleaned, for example, with a high-pressure water jet, without the water penetrating the connector.

The basic sealed construction is further optimised in the preferred embodiments in such a way that a kind of chamber of the ring seals is formed by the supporting of at least one of the seals on an annular collar on the plug or socket part and a funnel-like inwardly directed chamfer on the front ends of the annular locking element, which impacts on the seals, owing to which the ring seals cover the external surfaces of the plug or socket parts flush with the front. Thus the dimensions of the gap and unevenness in the outer contour of the connector are further minimised and the collection of dirt prevented.

According to another preferred embodiment, the locking element is constructed as a clamping nut and can be screwed to the plug or socket part via a bayonet-type short thread. This short thread has the advantage over an actual bayonet lock that the longitudinal axial movement of the clamping nut produces a considerable pressing force on the seal loaded by the clamping nut during screwing, and this further improves the hermetic sealing of the sealed space.

Furthermore, the clamping nut is fixed in its screwed position in the bayonet-type short thread, this being achieved as a result of the retention shoulders and retention recesses, arranged in the alternately engaging thread webs. The seal, which is loaded by the screwing of the clamping nut, acts as a spring loading on the interlocking of retention shoulder and retention recess in the short thread owing to its inherent restoring forces, so that the closed position of the clamping nut is additionally secured. The seal therefore fulfils altogether a double function.

According to other preferred embodiments, a rotational indexation between plug and socket parts is provided, by which the two parts can be engaged with each other in a plurality of defined rotational positions. In the state where they have been guided into each other there is then a simultaneous rotational retention of plug and socket parts, so that the clamping nut can be screwed onto its cooperating part of the connector without the connector having to be held by hand to prevent it from rotating.

### BRIEF DESCRIPTION OF THE DRAWINGS

Further features, details and advantages of the invention will emerge from the description hereinafter, in which an embodiment is described in detail with reference to the accompanying drawings. They show:

FIG. 1 a side view of a connector between a measuring sensor and a measuring signal cable in the closed state,

FIG. 2 a perspective view of the connector according to FIG. 1 in the open state, and

FIG. 3 an axial section through the connector along section line III-III in FIG. 1.

### DESCRIPTION OF THE PREFERRED EMBODIMENT

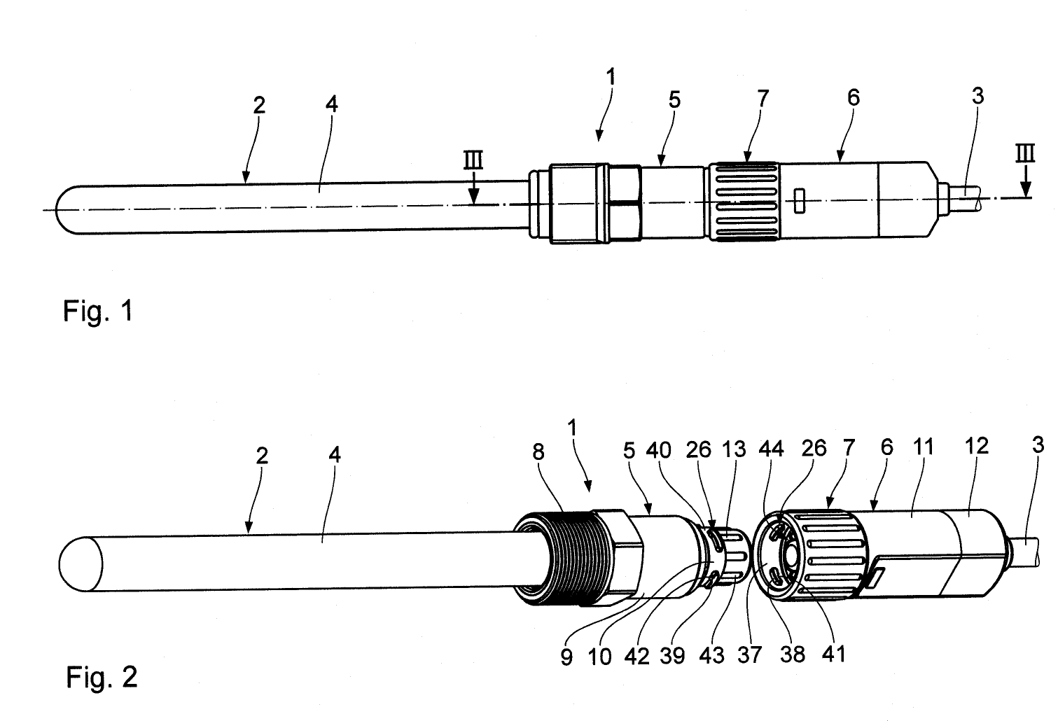

Referring to FIG. 1, the connector designated as a whole as 1 has the function of coupling an electrochemical measuring sensor 2, such as a pH sensor, for example, to a signal cable 3, which leads to a field device, which is not shown in detail herein, to form a signalling system.

The connector 1 has three main components, namely the electrode plug 5, which is located directly on the electrode body 4 of the measuring sensor 2, the cable socket 6, which is connected to the signal cable 3, and the clamping nut 7, which connects the electrode plug 5 and the cable socket 6.

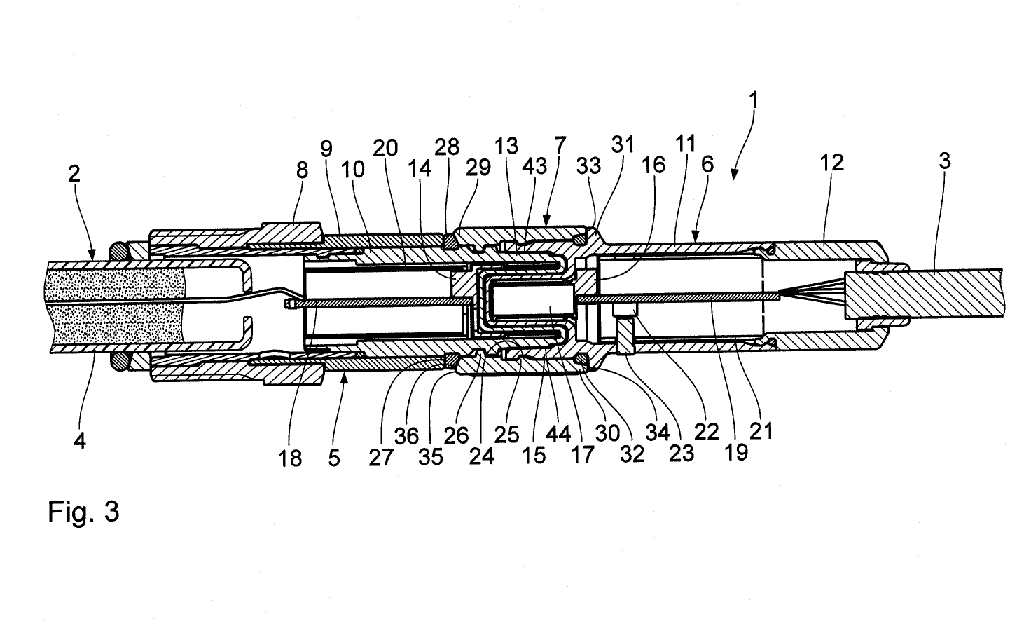

Referring in particular to FIG. 3, the electrode plug 5 is formed by a plurality of individual sleeve elements 8, 9, 10, which are hermetically connected to each other and sealed, the detailed design of which is not important for the present invention and therefore needs no further description. This is also the case for the corresponding sleeve parts 11, 12 of the cable socket 6.

At its free end the electrode plug 5 has a plug collar part 13, in which a coil member 14 with coil windings, which are not shown in detail, of a first induction coil is arranged. The induction coil cooperates with a second induction coil, which is arranged centrally in the sleeve shaped receptacle 15 of the cable socket 6 and is arranged with its coil member 16 on a ferrite core 17 located centrally in the coil member 16. The two induction coils (not shown in detail) form a contactless inductive transmission path for the measurement signals supplied by the measurement sensor. The measurement signals are converted by a signal processing circuit, which is not shown in detail, on the printed circuit board 18, so that they can be transmitted via the inductive transmission path between electrode plug 5 and cable socket 6. The signals received by the induction coil in the cable socket 6 are in turn extracted in a circuit, likewise not shown in detail, on the printed circuit board 19 in the cable socket 6 and sent on via the signal cable 3.

The circuits on the two printed circuit boards 18, 19 of the electrode plug 5 and the cable socket 6 are shielded by shields 20, 21. Light-emitting diodes 22 provided in the circuit of the cable socket 6 display the operating state of the signal transmitting path between electrode plug 5 and cable socket 6. The light signal of the light-emitting diodes 22 is fed to the exterior via a light guide 23 and made visible to an operator.

Referring to FIG. 3, the sleeve-shaped clamping nut 7 is fixed in a longitudinal axial direction in a circumferential annular groove 24 of the cable socket 6 with the aid of an annular shoulder 25, which engages therein, but is, however, still rotatable relative to the cable socket 6. With its free end the clamping nut 7 overlaps the plug collar 13 of the electrode plug 5, where it can be screwed to the electrode plug 5 via a bayonet-type short thread 26, which will be described in detail hereinafter.

The electrode plug 5 has an annular shoulder 27 in the region of the back end of its plug collar 13, in front of which an ‘O’ ring seal 28 is located. The ‘O’ ring is loaded by the front end 29 of the clamping nut 7, which is turned towards it, in the position where the electrode plug 5 and the cable socket 6 are fixed together, as shown in FIG. 3. Thus the gap between clamping nut and electrode plug 5 is hermetically sealed from the outside against the penetration of substances.

Similarly, a circumferential annular shoulder 31 is provided on the back end of the receptacle 15 of the cable socket 6, in front of which another ‘O’ ring seal 32 is located. The ‘O’ ring seal comes to rest in an inwardly directed funnel-like chamfer 33 of the front edge 34 on the front end 30 of the clamping nut 7 on the cable sleeve side. The ‘O’ ring seal 32 is thereby located in a chamber between clamping nut 7 and cable socket 6 and seals both components hermetically against the penetration of substances from the outside on this side as well.

Referring also to FIG. 3, the front edge 35 on the front end 29 of the clamping nut 7 on the electrode plug side also has a slightly less pronounced funnel-like inwardly directed chamfer 36, so that a kind of chamber is also created here by the ‘O’ ring seal 28 when the components of the connector 1 are engaged with each other and screwed together.

The above-mentioned short thread 26 can be described with reference to FIG. 2. It is formed on the one hand by short thread webs 38, which are distributed evenly over the inner perimeter 37 on the edge of the clamping nut 7 on the electrode plug side. These thread webs 38 cooperate with thread webs 39, which are adapted to them in quantity and length, and which on the other hand are distributed over the outer perimeter 40 of the plug collar 13 of the electrode plug 5. In the fixed position shown in FIG. 3 the thread webs 38, 39 engage with each other alternately and provide a fixing together of electrode plug 5 and cable socket 6 in the position shown in FIG. 3 owing to the relative rotation between clamping nut 7 and electrode plug 5.

Referring to FIG. 2, the thread webs 38 on the clamping nut 7 have a retention recess 41 on their lateral side directed away from the electrode plug 5, which cooperate with corresponding retention shoulders 42 directed away from the cable socket 6 on the thread webs 39 on the electrode plug 5. In the screwed-in end position of the connector components shown in FIGS. 1 and 3, the retention shoulders 42 lock into the respective retention recesses 41 of the thread webs 38, 39. This locking grip is additionally enhanced by the inherent restoring forces in the ‘O’ ring seal 28 on the electrode plug 5, so that the closed position of the connector 1 is held reliably. The unscrewing of the clamping nut 7 takes place only by overriding a noticeable initial resistance.

Referring also to FIG. 2, the plug and socket parts are provided with rotational indexation, which is formed by longitudinal axial webs 43 distributed evenly over the outer perimeter of the plug collar 13 and internal toothing 44 inside the cable socket 6. The internal toothing 44 has 24 longitudinal grooves, which cooperate with the eight longitudinal webs 43. In this respect the electrode plug 5 and cable socket 6 can be pushed inside each other in rotational positions staggered by 15° each to fix them to each other. As soon as both parts are pushed inside each other they can no longer rotate relative to each other, so the connector 1 is closed and retained with a screwing movement of the clamping nut 7.

The electrode plug 5, cable socket 6 and clamping nut 7 are additionally manufactured from plastics materials that are resistant to acids and alkalies, and moreover are of food grade and a light colour. It is also to be recommended that the surfaces of the components are designed with the smoothest possible surface, in order to make it difficult for substances to stick to them.

What is claimed is:

1. A connector for the transmission of signals, in particular for the contactless inductive transmission of measurement signals, comprising
a socket part (6)
a plug part (5), which engages with the latter,
an annular locking element (7) in particular between the socket and plug parts (5, 6) to fix the insertion position of the plug part (5) inside the socket part (6), and
a respective seal (28, 32) in the region of the front ends (29, 30) of the annular locking element (7) to seal the engagement zone between plug and socket parts (5, 6) against the penetration of substances from outside.

2. Connector according to claim 1, wherein one of the seals (28) is located on the plug or socket part (5, 6) and when loaded by the annular locking element (7) during the fixing process, is supported against an annular shoulder (27) on the socket or plug part (5, 6).

3. Connector according to claim 1, wherein the front ends (34, 35) of the annular locking element (7), which load the respective seals (28, 32), have inwardly directed funnel-like chamfers (33, 36).

4. Connector according to claim 1, wherein the annular locking element (7) is rotatably fixed on the socket or plug part (5, 6) and can be screwed to the plug or socket part (5, 6) via a bayonet-type short thread (26).

5. Connector according to claim 4, wherein the short thread (26) is formed by thread webs (38, 39) which are distributed over the internal contour (37) of the annular locking element (7) and the external contour (40) of the plug or socket part (5, 6) respectively, and which engage with each other alternately when the annular locking element (7) and the plug or socket part (5, 6) are screwed together.

6. Connector according to claim 5, wherein the thread webs (38, 39) which engage with each other alternately are each provided with a retention shoulder (42) on one hand and with a retention recess on the other, which engage with each other to secure the screwing of the annular locking element (7) and the plug or socket part (5, 6) in the final screwed position.

7. Connector according to claim 6, wherein the mutual engagement of retention shoulder (42) and retention recess (41) is additionally secured by the restoring forces of the seal (28), which is loaded during the screwing of the annular locking element (7).

8. Connector according to claim 1, wherein the plug and socket part (5, 6) is provided with rotational indexation (43, 44) for guiding the two parts (5, 6) into each other only in defined rotational positions and up to the rotational retention of the two parts (5, 6) in the state where they are guided into each other.

9. Connector according to claim 8, wherein the rotational indexation is formed by longitudinally axial webs (43) on the external contour (40) of the plug part (5) and an internal toothing (44) on the internal contour (37) of the socket part (6).

10. Connector according to claim 1, wherein at least one of the plug, socket part (5, 6) or annular locking element (7) consist of food grade, stable plastics materials of light colour.
